(19) United States
(12) Patent Application Publication
(10) Pub. No.: US 2024/0412112 A1
(43) Pub. Date: Dec. 12, 2024

(54) TRAINING DATA GENERATION METHOD, TRAINING DATA GENERATION DEVICE, AND RECORDING MEDIUM

(71) Applicant: Panasonic Intellectual Property Corporation of America, Torrance, CA (US)

(72) Inventors: Yasunori ISHII, Osaka (JP); Kazuki Kozuka, Osaka (JP); Hironobu Fujiyoshi, Aichi (JP); Takayoshi Yamashita, Aichi (JP); Tsubasa Hirakawa, Aichi (JP)

(21) Appl. No.: 18/808,592

(22) Filed: Aug. 19, 2024

Related U.S. Application Data
(63) Continuation of application No. PCT/JP2023/007102, filed on Feb. 27, 2023.
(60) Provisional application No. 63/315,655, filed on Mar. 2, 2022.

(51) Int. Cl. G06N 20/00

(52) U.S. Cl. CPC G06N 20/00

(57) ABSTRACT

A training data generation method for generating training data for training a recognition model that is input with image data and outputs one of a plurality of classes as a class of an object present in the image data, the training data generation method including: selecting a first class from the plurality of classes based on a recognition accuracy of the recognition model; calculating an inter-class distance that is a distance between the first class and each of two or more other classes among the plurality of classes; selecting a second class for generating the training data from the two or more other classes, based on the inter-class distance; and generating the training data by mixing image data and labels of each of the first class selected and the second class selected.

### CROSS REFERENCE TO RELATED APPLICATIONS

This is a continuation application of PCT International Application No. PCT/JP2023/007102 filed on Feb. 27, 2023, designating the United States of America, which is based on and claims priority of U.S. Provisional Patent Application No. 63/315,655 filed on Mar. 2, 2022. The entire disclosures of the above-identified applications, including the specifications, drawings and claims are incorporated herein by reference in their entirety.

### FIELD

The present disclosure relates to a training data generation method, a training data generation device, and a recording medium.

### BACKGROUND

Recognition techniques are known which use recognition models trained using machine learning to recognize objects present in image data (images). Such machine learning methods include supervised machine learning, in which the recognition model is trained using training data which includes image data and labels (correct labels) for the objects present in the image data.

Recognition models tend to provide higher recognition accuracy with more training data. As such, techniques for generating and augmenting training data, called “data augmentation”, are being investigated. NPL 1 discloses a technique for generating composite image data, serving as training data, by mixing two items of image data and labels thereof.

### CITATION LIST

### Non Patent Literature

NPL 1: mixup: Beyond Empirical Risk Minimization: ICLR 2018

### SUMMARY

### Technical Problem

However, NPL 1 describes generating composite image data by mixing random image data, which means it may not be possible to generate image data for a small number of classes. It is therefore difficult to effectively train a recognition model that improves performance for classes with low accuracy.

Accordingly, the present disclosure provides a training data generation method, a training data generation device, and a recording medium that generate training data capable of effectively training a recognition model.

### Solution to Problem

A training data generation method according to one aspect of the present disclosure is a training data generation method for generating training data for training a recognition model that is input with image data and outputs one of a plurality of classes as a class of an object present in the image data, and includes: selecting a first class from the plurality of classes based on a recognition accuracy of the recognition model; calculating an inter-class distance that is a distance between the first class and each of two or more other classes among the plurality of classes; selecting a second class for generating the training data from the two or more other classes, based on the inter-class distance; and generating the training data by mixing image data and labels of each of the first class selected and the second class selected.

A training data generation device according to one aspect of the present disclosure is a training data generation device that generates training data for training a recognition model that is input with image data and outputs one of a plurality of classes as a class of an object present in the image data, and includes: a first selector that selects a first class from the plurality of classes based on a recognition accuracy of the recognition model; a calculator that calculates an inter-class distance that is a distance between the first class and each of two or more other classes among the plurality of classes; a second selector that selects a second class for generating the training data from the two or more other classes, based on the inter-class distance; and a generator that generates the training data by mixing image data and labels of each of the first class selected and the second class selected.

Additionally, a recording medium according to one aspect of the present disclosure is a non-transitory computer-readable recording medium having recorded thereon a program for causing a computer to execute the training data generation method described above.

### Advantageous Effects

According to one aspect of the present disclosure, a training data generation method and the like that generate training data capable of effectively training a recognition model can be provided.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the functional configuration of a training data generation device according to an embodiment.

FIG. 2 is a block diagram illustrating the functional configuration of a low-frequency class selector according to the embodiment.

FIG. 3 is a flowchart illustrating operations by the training data generation device according to the embodiment.

FIG. 4 is a flowchart illustrating the operations of step S10 of FIG. 3 in detail.

FIG. 5A is a diagram illustrating a first example of a method for selecting a low-frequency class according to the embodiment.

FIG. 5B is a diagram illustrating a second example of a method for selecting a low-frequency class according to the embodiment.

FIG. 6 is a flowchart illustrating the operations of step S20 of FIG. 3 in detail.

FIG. 7 is a flowchart illustrating the operations of step S30 of FIG. 3 in detail.

FIG. 8A is a diagram illustrating a first example of a method for selecting a class to be mixed with a low-frequency class according to the embodiment.

FIG. 8B is a diagram illustrating a second example of a method for selecting a class to be mixed with a low-frequency class according to the embodiment.

### DESCRIPTION OF EMBODIMENT

### Circumstances Leading to the Present Disclosure

Training data is collected when training a recognition model, but it is difficult to collect data for all classes evenly, and recognition models trained on such training data may exhibit different recognition rates from class to class. For example, the recognition performance may drop for a low-frequency class, which is a class for which a small number of items of data is included in the training data. Although additional data can be collected for a low-frequency class, doing so increases the collection cost, which is problematic. Note that the training data is a set of data that includes image data and a label indicating a class of an object included in the image data (a data set).

Accordingly, after diligently investigating training data generation methods and the like capable of generating training data that can improve recognition performance for low-frequency classes while suppressing an increase in the collection cost, the inventors of this application arrived at the training data generation method and the like described herein.

A training data generation method according to a first aspect of the present disclosure is a training data generation method for generating training data for training a recognition model that is input with image data and outputs one of a plurality of classes as a class of an object present in the image data, and includes: selecting a first class from the plurality of classes based on a recognition accuracy of the recognition model; calculating an inter-class distance that is a distance between the first class and each of two or more other classes among the plurality of classes; selecting a second class for generating the training data from the two or more other classes, based on the inter-class distance; and generating the training data by mixing image data and labels of each of the first class selected and the second class selected.

Through this, training data that includes image data having the features of corresponding objects present in the image data belonging to the first class and the second class can be generated, which makes it possible to improve the recognition performance of the recognition model by training the recognition model using such image data. For example, if the recognition accuracy for the first class is low, training data can be generated that can effectively improve the recognition accuracy for classes having low recognition accuracy. As such, according to the training data generation method, training data that can effectively train a recognition model can be generated.

A training data generation method according to a second aspect of the present disclosure may be the training data generation method according to the first aspect, further including, for example, extracting, as at least one candidate class, at least one of a class for which the recognition accuracy is at most a first threshold, or a class for which the recognition accuracy is at least a second threshold higher than the first threshold, among the plurality of classes. In the selecting of the first class, the first class may be selected from the at least one candidate class.

Through this, training data can be generated that can effectively improve the recognition accuracy for classes having a recognition accuracy that is not greater than the first threshold or greater than the second threshold.

A training data generation method according to a third aspect of the present disclosure may be the training data generation method according to the second aspect, wherein, for example, in the selecting of the first class, the first class may be selected at random from the at least one candidate class.

Through this, training data can be generated that can effectively improve the recognition accuracy for the first class selected at random.

A training data generation method according to a fourth aspect of the present disclosure may be the training data generation method according to any one of the first to third aspects, wherein, for example, in the calculating of the inter-class distance, the inter-class distance may be calculated based on a likelihood of each of the plurality of classes, output by the recognition model.

Through this, the likelihood of each of the plurality of classes, which is the recognition result of the recognition model, can be used to select the second class. The training data generated by mixing the second class and the first class selected in this manner may be training data that can more accurately train the boundary between the likelihoods of the first class and the second class.

A training data generation method according to a fifth aspect of the present disclosure may be the training data generation method according to the fourth aspect, further including, for example: obtaining the likelihood for each of one or more items of first evaluation data corresponding to the first class, among evaluation data used to calculate the recognition accuracy; determining whether a variance of the likelihood of each of the one or more items of first evaluation data is greater than a third threshold; and determining the likelihood of the first class used to calculate the inter-class distance based on a result of the determining of whether the variance is greater than the third threshold.

Through this, different likelihoods can be obtained depending on the result of determining the variance, which makes it possible to generate training data capable of effectively training a recognition model compared to a case where the likelihoods are obtained regardless of the result of determining the variance.

A training data generation method according to a sixth aspect of the present disclosure may be the training data generation method according to the fifth aspect, wherein, for example, in the calculating of the inter-class distance, when the variance is greater than the third threshold, the inter-class distance may be calculated using the likelihood of evaluation data, among the one or more items of first evaluation data, for which a recognition result is correct, and in the calculating of the inter-class distance, when the variance is not greater than the third threshold, the inter-class distance may be calculated using the likelihood of evaluation data, among the one or more items of first evaluation data, for which the recognition result is incorrect.

Through this, the likelihood of the evaluation data that is the correct answer is used when there is high variation in the likelihoods of the first class, which makes it possible to suppress the influence of outliers. On the other hand, the likelihood of the evaluation data that is an incorrect answer is used when there is little variation in the likelihoods of the first class, which makes it less likely that the data will be mistaken for data resembling another class.

A training data generation method according to a seventh aspect of the present disclosure may be the training data generation method according to any one of the fourth to sixth aspects, wherein, for example, the inter-class distance may be a Mahalanobis distance, a Euclidean distance, a Manhattan distance, or a cosine similarity. Through this, either a Mahalanobis distance, a Euclidean distance, a Manhattan distance, or a cosine similarity can be used as the inter-class distance.

A training data generation method according to an eighth aspect of the present disclosure may be the training data generation method according to any one of the first to seventh aspects, further including, for example, calculating an accuracy rate of a recognition result from the recognition model for the first class, wherein in the selecting of the second class, the second class may be selected from the two or more other classes based on the accuracy rate calculated and the inter-class distance.

Through this, the second class is selected based on the accuracy rate of the first class, which makes it possible to select a second class that can improve the accuracy rate of the first class, for example.

A training data generation method according to a ninth aspect of the present disclosure may be the training data generation method according to the eighth aspect, wherein, for example, in the selecting of the second class, when the accuracy rate of the first class is greater than a fourth threshold, a class, among the two or more other classes, for which the inter-class distance is small may be selected as the second class, and in the selecting of the second class, when the accuracy rate of the first class is not greater than the fourth threshold, a class, among the two or more other classes, for which the inter-class distance is great may be selected as the second class.

Through this, different classes are selected as the second class depending on the accuracy rate, which makes it possible to effectively train the recognition model compared to a case where the second class is selected regardless of the accuracy rate.

A training data generation method according to a tenth aspect of the present disclosure may be the training data generation method according to the first to ninth aspects, further including, for example: obtaining one or more items of first evaluation data corresponding to the first class and one or more items of second evaluation data corresponding to the second class, from evaluation data including image data and a label used to calculate the recognition accuracy; obtaining a mixing rate at which to mix the one or more items of first evaluation data obtained and the one or more items of second evaluation data obtained; and generating the training data by mixing the one or more items of first evaluation data and the one or more items of second evaluation data based on the mixing rate obtained.

Through this, the training data can be generated based on the obtained mixing rate.

A training data generation device according to an eleventh aspect of the present disclosure is a training data generation device that generates training data for training a recognition model that is input with image data and outputs one of a plurality of classes as a class of an object present in the image data, and includes: a first selector that selects a first class from the plurality of classes based on a recognition accuracy of the recognition model; a calculator that calculates an inter-class distance that is a distance between the first class and each of two or more other classes among the plurality of classes; a second selector that selects a second class for generating the training data from the two or more other classes, based on the inter-class distance; and a generator that generates the training data by mixing image data and labels of each of the first class selected and the second class selected. Additionally, a recording medium according to a twelfth aspect of the present disclosure is a non-transitory computer-readable recording medium having recorded thereon a program for causing a computer to execute the training data generation method according to any one of the first to tenth aspects. This provides the same effects as those of the above-described training data generation method.

Note that these comprehensive or specific aspects may be realized by a system, a method, an integrated circuit, a computer program, or a non-transitory computer-readable recording medium such as a CD-ROM, or may be implemented by any desired combination of systems, methods, integrated circuits, computer programs, and recording media. The program may be stored in advance in a recording medium, or may be supplied to the recording medium over a wide-area communication network including the Internet.

An embodiment will be described in detail hereinafter with reference to the drawings.

The following embodiment will describe a general or specific example. The numerical values, constituent elements, arrangements and connection states of constituent elements, steps, orders of steps, and the like in the following embodiments are merely examples, and are not intended to limit the present disclosure. Additionally, of the constituent elements in the following embodiment, constituent elements not denoted in the independent claims will be described as optional constituent elements.

Additionally, the drawings are schematic diagrams, and are not necessarily exact illustrations. As such, the scales and the like, for example, are not necessarily consistent from drawing to drawing. Furthermore, configurations that are substantially the same are given the same reference signs in the drawings, and redundant descriptions will be omitted or simplified.

Additionally, in the present specification, numerical values and numerical value ranges do not express the items in question in the strictest sense, and also include substantially equivalent ranges, e.g., differences of about several percent (or about 10%), as well.

In addition, in the present specification, unless otherwise specified, ordinals such as “first” and “second” do not refer to the number or order of the constituent elements, and are rather used for the purpose of avoiding confusion and distinguishing between constituent elements of the same kind.

### Embodiment

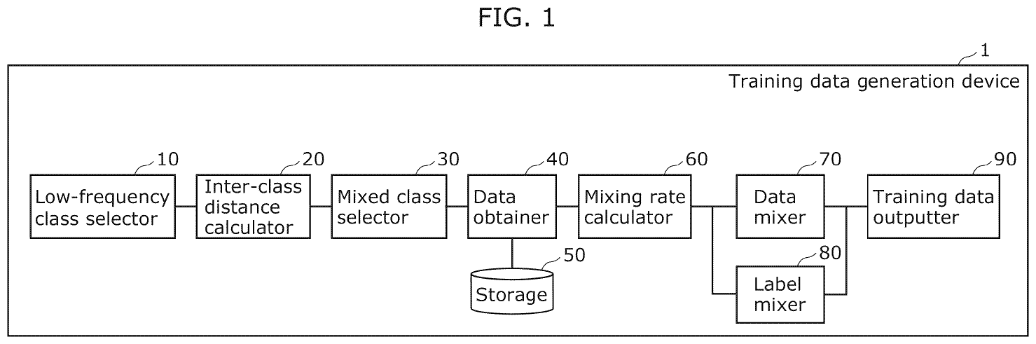

A training data generation method and the like according to the present embodiment will be described hereinafter with reference to FIGS. 1 to 8B.

### 1. Configuration of Training Data Generation Device

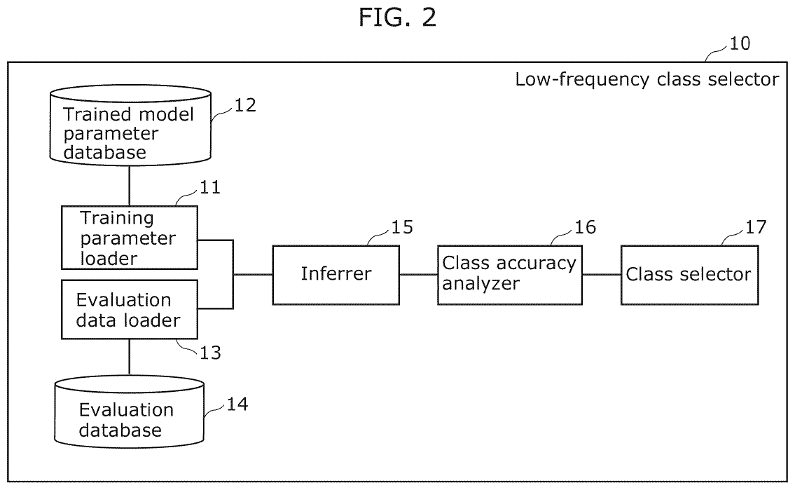

First, the configuration of a training data generation device according to the present embodiment will be described with reference to FIGS. 1 and 2. FIG. 1 is a block diagram illustrating the functional configuration of training data generation device 1 according to the present embodiment. Training data generation device 1 is an information processing device that generates training data for training (e.g., re-training) a recognition model. Specifically, training data generation device 1 is an information processing device that, from existing training data, generates training data for improving recognition performance of the recognition model for a class which has low recognition performance due to, for example, the number of items of data in the training data being small.

As illustrated in FIG. 1, training data generation device 1 includes low-frequency class selector 10, inter-class distance calculator 20, mixed class selector 30, data obtainer 40, storage 50, mixing rate calculator 60, data mixer 70, label mixer 80, and training data outputter 90. Processing by each of the function blocks of training data generation device 1 is normally realized by a program executor such as a processor reading out and executing software (a program) recorded in a recording medium such as a ROM.

Low-frequency class selector 10 selects a low-frequency class from among a plurality of classes based on a recognition accuracy (e.g., a recognition rate) of the recognition model. Low-frequency class selector 10 makes inferences using, for example, a recognition model trained in advance, and selects the low-frequency class based on the recognition accuracy of each of the plurality of classes. The low-frequency class is a class, among the plurality of classes, for which training has not been performed well, and therefore cannot be recognized accurately. A recognition model may misrecognize an object of a low-frequency class as belonging to another class, or may misrecognize an object of another class as belonging to a low-frequency class.

Low-frequency class selector 10 is an example of a “first selector”, and the low-frequency class is an example of a “first class”. The training data used in the advance training is, for example, training data in which each class has a different number of samples. Training data generation device 1 generates training data when, for example, re-training a recognition model trained through machine learning using training data in which each class has a different number of samples.

The configuration of low-frequency class selector 10 will be described here with reference to FIG. 2. FIG. 2 is a block diagram illustrating the functional configuration of low-frequency class selector 10 according to the present embodiment.

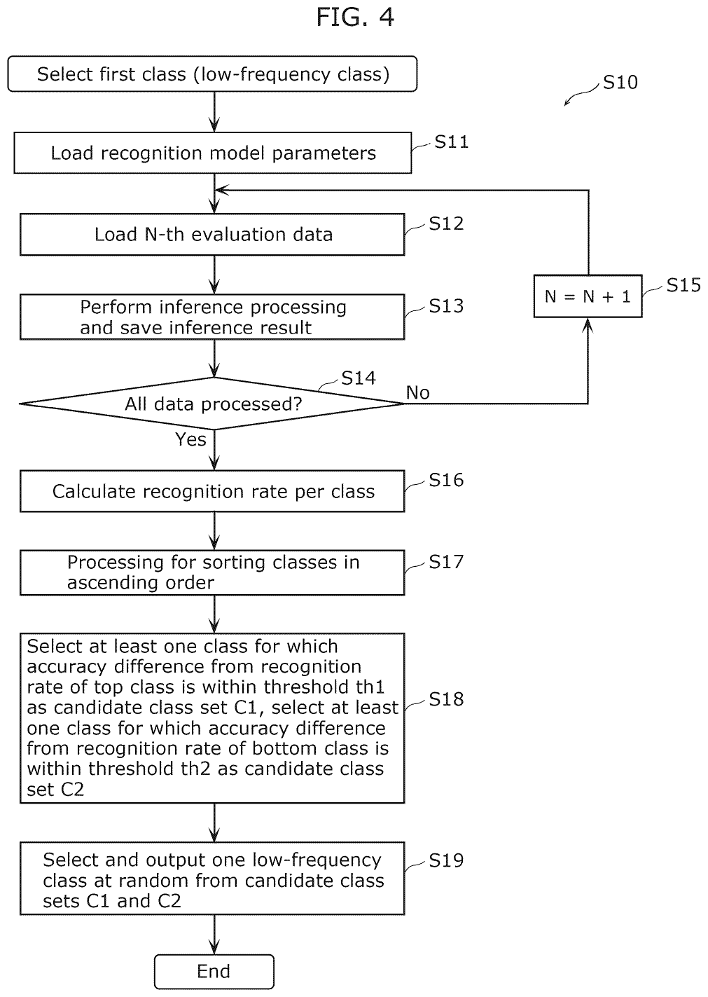

As illustrated in FIG. 2, low-frequency class selector 10 includes training parameter loader 11, trained model parameter database 12, evaluation data loader 13, evaluation database 14, inferrer 15, class accuracy analyzer 16, and class selector 17. The processing of each constituent element will be described in detail later with reference to FIG. 4 and the like.

Training parameter loader 11 loads (reads out) parameters of a recognition model from trained model parameter database 12.

The recognition model is a model used for image recognition, and is a mathematical model also called a learning model. The recognition model is configured to be capable of identifying to which class, among the plurality of classes, an object present in image data belongs. The recognition model may be a recognition model having parameters provided in advance (initial values), or may be a recognition model having new parameters obtained by updating the stated parameters provided in advance through machine learning using the training data prepared in advance (that is, a trained recognition model). The recognition model is a model that takes image data as an input and outputs which of the plurality of classes an object present in the image data belongs to. The recognition model can also output in matrix format (vector format) having one row and M columns (where M is the number of the plurality of classes), with a likelihood of the object belonging to each of the plurality of classes as an element. The matrix (vector) having one row and M columns output from the recognition model is called a “class probability” or a “likelihood vector”. The likelihood for each of the plurality of classes included as elements of the class probability is a value indicating the confidence that the object belongs to the class. The recognition model recognizes that the class with the highest likelihood among the likelihoods for each of the plurality of classes output in response to the input image data is the class to which the object present in the image data belongs, as described above. The recognition model is, for example, a neural network model, but is not limited thereto.

The recognition model may be an image segmentation model that classifies each pixel into a class.

Although the following will describe an example in which the recognition model is an object recognition model that recognizes an object from image data, the recognition model may be, for example, a text recognition model that recognizes a text from image data, or another type of recognition model. If the recognition model is an object recognition model installed in a vehicle, the classes are, for example, a vehicle, a person, a road, a sidewalk, a building, a traffic signal, or the like, and if the recognition model is a text recognition model, the classes are, for example, characters themselves. The training data and evaluation data described below each include image data including at least one of an object corresponding to a class and a label (a correct label) for the objects.

Trained model parameter database 12 is a storage device that stores parameters of one or more recognition models. The parameters are, for example, various parameters of a neural network that is a recognition model. Trained model parameter database 12 is realized by a semiconductor memory, for example, but is not limited thereto.

Evaluation data loader 13 loads evaluation data for causing the recognition model read out by training parameter loader 11 to make an inference for selecting a low-frequency class from evaluation database 14. The present embodiment will describe an example in which image data is the evaluation data.

Evaluation database 14 is a storage device that stores a plurality of items of evaluation data. The plurality of items of evaluation data include the plurality of classes that the recognition model uses for classification. Evaluation database 14 is realized by a semiconductor memory, for example, but is not limited thereto.

Inferrer 15 executes inference processing for the evaluation data loaded by evaluation data loader 13 using the parameters of the recognition model loaded by training parameter loader 11. As a result of the inference processing, inferrer 15 obtains the class of an object present in the evaluation data, obtained by inputting the evaluation data into the recognition model. Additionally, inferrer 15 may obtain, as a result of the inference processing, a result obtained by inputting the evaluation data into the recognition model and outputting a matrix format that takes, as elements, likelihoods indicating the confidence of determining that an object present in the evaluation data belongs to each of the plurality of classes, as output from the recognition model.

Class accuracy analyzer 16 determines, based on the inference result from inferrer 15 and the correct labels, whether the output of the recognition model is correct, and calculates, from determination results for the same class, a recognition rate (also referred to as an “accuracy rate”) of the recognition model for that class.

Class selector 17 selects a low-frequency class from the plurality of classes based on the recognition rate for each class calculated by class accuracy analyzer 16.

Referring again to FIG. 1, inter-class distance calculator 20 calculates an inter-class distance between the low-frequency class and two or more other classes among the plurality of classes. The inter-class distance will be described as, for example, a distance calculated from the likelihoods of the plurality of classes output from the recognition model when the evaluation data is input to the recognition model, but the inter-class distance is not limited thereto. For example, if the recognition model is a neural network, a distance calculated from the outputs (features) from the intermediate layers of the neural network may be taken as the inter-class distance. To be more specific, in the present embodiment, the inter-class distance is a distance (e.g., a relative distance) calculated based on a covariance matrix of the likelihood output by the recognition model for image data of the low-frequency class and the likelihoods output by the recognition model for image data of the two or more other classes. The covariance matrix and the calculation of the inter-class distance will be described in detail later.

Mixed class selector 30 selects one class to be mixed with the low-frequency class based on the inter-class distances between the low-frequency class and each of the two or more other classes. Mixed class selector 30 is an example of a “second selector”. The selection of the class to be mixed with the low-frequency class will be described later. Note that the class selected by mixed class selector 30 is an example of a “second class”. In the following, the class selected by mixed class selector 30 will also be referred to as a “class to be mixed”.

Data obtainer 40 reads out the image data and the labels of the low-frequency class and the class to be mixed from storage 50.

Storage 50 is a storage device that stores data (image data and labels) for generating training data for improving the recognition performance for the low-frequency class. Storage 50 may be realized by evaluation database 14. Storage 50 may store the evaluation data. Storage 50 is realized by semiconductor memory or the like, for example, but is not limited thereto.

Mixing rate calculator 60 calculates a mixing rate (weight) used when mixing first image data of the low-frequency class and the correct label of the first image data (a first correct label) with second image data of the class to be mixed and the correct label of the second image data (a second correct label). The mixing rate used when mixing the first image data with the second image data and the mixing rate when mixing the first correct label with the second correct label are the same mixing rate. Mixing rate calculator 60 may calculate the mixing rate randomly. The mixing rate is a value from 0 to 1. Mixing rate calculator 60 may set a first mixing rate of the low-frequency class to a value lower than a second mixing rate of the class to be mixed, may set the first mixing rate and the second mixing rate to the same value (=0.5), or may set the first mixing rate to a value higher than the second mixing rate. The sum of the first mixing rate and the second mixing rate is 1.

Note that the first correct label and the second correct label may be labels that represent a single correct class, or may be labels that represent a plurality of likelihoods for a plurality of classes. For example, the first correct label may have a likelihood of 100% (i.e., 1) for a correct class for the object present in the first image data, and a likelihood of 0% (i.e., 0) for each other class. The second correct label may have a likelihood of 100% (i.e., 1) for a correct class for the object present in the second image data, and a likelihood of 0% (i.e., 0) for each other class.

Data mixer 70 generates additional image data for training (composite image data) by mixing the first image data and the second image data at the mixing rate calculated by mixing rate calculator 60. It can also be said that data mixer 70 generates one item of composite image data (pseudo data) by combining the first image data and the second image data. Data mixer 70 generates the composite image data by, for example, weighting and adding the pixel values of the same pixel in the first image data and the second image data. For example, the composite image data includes two or more objects of different classes.

Label mixer 80 generates an additional correct label corresponding to the composite image data generated by data mixer 70 (a composite correct label) by mixing the first correct label and the second correct label at the mixing rate calculated by mixing rate calculator 60 (the same mixing rate as the image data mixed by data mixer 70). It can also be said that label mixer 80 generates a composite correct label by compositing the first correct label and the second correct label. Label mixer 80 generates the composite correct label by weighting and adding the likelihoods of the same class for the first correct label and the second correct label. For example, the composite correct label includes a likelihood for each of the plurality of classes including the class of the object present in the composite image data.

An example of composite image data and the composite correct label will be described here. A case will be described here where a dog appears in the first image data, the first correct label has a likelihood of 100% (i.e., 1) for a dog, a cat appears in the second image data, and the second correct label has a likelihood of 100% (i.e., 1) for a cat, and these are mixed at a mixing rate of 0.5. Note that “cat” and “dog” are examples of classes.

The composite image data is image data generated by weighting and adding the first image data and the second image data at the mixing rate determined by mixing rate calculator 60, and is, for example, image data in which both a dog and a cat are present (e.g., image data in which at least a dog and a cat overlap at least partially).

The composite correct label is a label in which the first correct label and the second correct label are weighted and added at the same mixing rate as the mixing rate used for compositing the first image data and the second image data. When the composite correct label is expressed as “(dog likelihood, cat likelihood)”, in the above example, the composite correct label is (0.5, 0.5).

Training data outputter 90 outputs training data, which includes the composite image data mixed by data mixer 70 and the composite correct label corresponding to the composite image data mixed by label mixer 80, to an information processing device such as a training device that trains the recognition model. Training data outputter 90 is configured including communication circuitry (a communication module).

By training (e.g., re-training) the recognition model using the training data generated in this manner, the accuracy for the low-frequency class can be effectively improved while suppressing costs such as costs involved in re-collecting data.

### 2. Operations of Training Data Generation Device

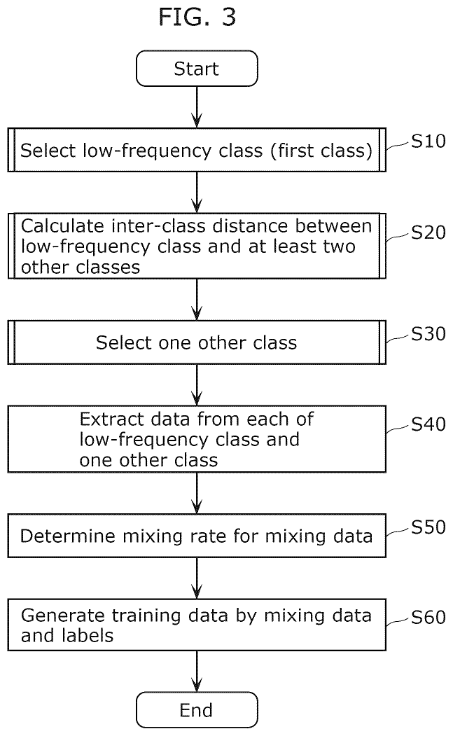

Operations of training data generation device 1 configured as described above will be described next with reference to FIGS. 3 to 8B. FIG. 3 is a flowchart illustrating operations by training data generation device 1 (a training data generation method) according to the present embodiment. FIG. 4 is a flowchart illustrating the operations of step S10 of FIG. 3 (the training data generation method) in detail.

As illustrated in FIG. 3, low-frequency class selector 10 selects a low-frequency class (the first class) from among the plurality of classes based on the recognition accuracy of the recognition model (S10). Specifically, low-frequency class selector 10 selects the low-frequency class based on the recognition accuracy of a recognition result that is the output from the recognition model obtained by inputting evaluation data into the recognition model.

As illustrated in FIG. 4, step S10 includes the processing of steps S11 to S19.

First, training parameter loader 11 loads the parameters of the recognition model to perform inference from trained model parameter database 12 (S11). Training parameter loader 11 outputs the loaded parameters of the recognition model to inferrer 15.

Next, evaluation data loader 13 loads N-th evaluation data from evaluation database 14 (N is a natural number of at least 1) (S12). Evaluation data loader 13 outputs the loaded evaluation data to inferrer 15.

Next, inferrer 15 executes inference processing and saves the inference result in storage (not shown) (S13). Inferrer 15 inputs the image data for evaluation into the recognition model, and obtains, as an inference result, the class of an object present in the image data for evaluation, which is the output of the recognition model.

Next, evaluation data loader 13 determines whether all the evaluation data has been processed (S14). Evaluation data loader 13 may make the determination of step S14 based on whether all of the evaluation data has been loaded from evaluation database 14. Note that the determination in step S14 may be made based on whether a predetermined number of items of data have been processed. In other words, all of the evaluation data does not necessarily have to be processed. Here, “processed” means that the processing of step S13 has been performed using the evaluation data.

If it is determined that all the evaluation data has not been processed (No in S14), evaluation data loader 13 takes N as N+1 (S15), after which the processing of steps S12 and on is performed for the next item of evaluation data. However, if it is determined that all the evaluation data has been processed (Yes in S14), the sequence moves to step S16.

Next, class accuracy analyzer 16 calculates the recognition rate (an example of a “recognition accuracy”) for each class (S16). Class accuracy analyzer 16 determines, for each item of evaluation data, whether the inference result matches the correct label, and calculates the recognition rate (the accuracy rate) for each class of object.

To simplify the descriptions, an example will be described where there are three classes of objects to be recognized (or classified) by the recognition model. In this case, the classes of objects to be recognized are a first object class (referred to as the “first class”), a second object class (referred to as the “second class”), and a third object class (referred to as a “third class”). In this case, when the image data which is the evaluation data is input into the recognition model, the recognition model calculates a value indicating the confidence that the object present in the image data is determined to belong to the first class (referred to as the “likelihood of the first class”), a value indicating the confidence that the object is determined to belong to the second object class (referred to as the “likelihood of the second class”), and a value indicating the confidence that the object is determined to belong to the third class (referred to as the “likelihood of the third class”), respectively, and outputs the values in the form of a matrix having one row and three columns. In other words, the matrix having one row and three columns, output as an inference result from the recognition model, includes the likelihood of the first class, the likelihood of the second class, and the likelihood of the third class as elements.

Inferrer 15 recognizes that the object of the class having the highest likelihood among the likelihood of the first class, the likelihood of the second class, and the likelihood of the third class included in the inference result is the class of the object present in the input image data.

On the other hand, when there are three classes of objects, the correct label corresponding to the evaluation data is, for example, a matrix having one row and three columns, where the likelihood of the class corresponding to the object actually present in the image data that is the evaluation data is 1, and the likelihood of other classes (objects not present in the image data) is 0. For each item of image data that is the evaluation data, class accuracy analyzer 16 determines whether the class of the object recognized based on the inference result matches the class corresponding to a likelihood of 1 in the correct label corresponding to the image data, and through this, determines whether the class corresponding to the object recognized based on the inference result matches the correct label.

For example, when one object among the three object classes belongs to a class “vehicle” and the recognition rate for the class “vehicle” is to be calculated, for example, class accuracy analyzer 16 extracts the inference result from the recognition model for the evaluation data corresponding to a correct label in which the likelihood of the class “vehicle” is 1 and the likelihoods of the remaining two object classes are 0, sets the object class recognized as “vehicle” based on the inference result as a correct answer, and sets the object classes recognized as classes aside from “vehicle” based on the inference result as incorrect answers. When, for example, there are ten items of evaluation data in which an object present in the evaluation data input to the recognition model is recognized as belonging to the class corresponding to “vehicle”, nine of those items of data are correct answers, and the remaining one item is an incorrect answer, class accuracy analyzer 16 calculates the recognition rate for the class “vehicle” as 90%.

Next, class accuracy analyzer 16 executes class ascending order sorting processing that sorts the classes in order from the class having the lowest recognition rate (S17).

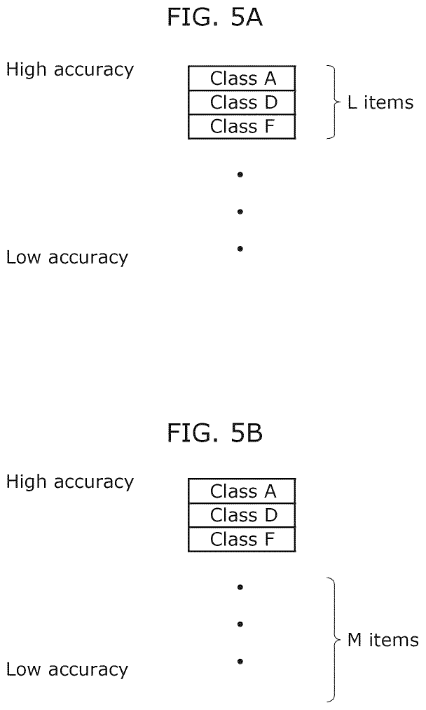

FIG. 5A is a diagram illustrating a first example of a method for selecting a low-frequency class according to the present embodiment.

As illustrated in FIG. 5A, class accuracy analyzer 16 sorts the classes in order of the recognition rate, from a low-accuracy class having the lowest recognition rate to a high-accuracy class having the highest recognition rate. FIG. 5A illustrates a case where class A has the highest recognition rate, and classes D and F have lower recognition rates, in that order.

Note that class accuracy analyzer 16 may execute class descending order sorting processing that sorts the classes in order from the class having the highest recognition rate.

Referring again to FIG. 4, class accuracy analyzer 16 then selects at least one class for which an accuracy difference from the recognition rate of the top class is within threshold th1 as candidate class set C1, and selects at least one class for which the accuracy difference from the recognition rate of the bottom class is within threshold th2 as candidate class set C2 (S18).

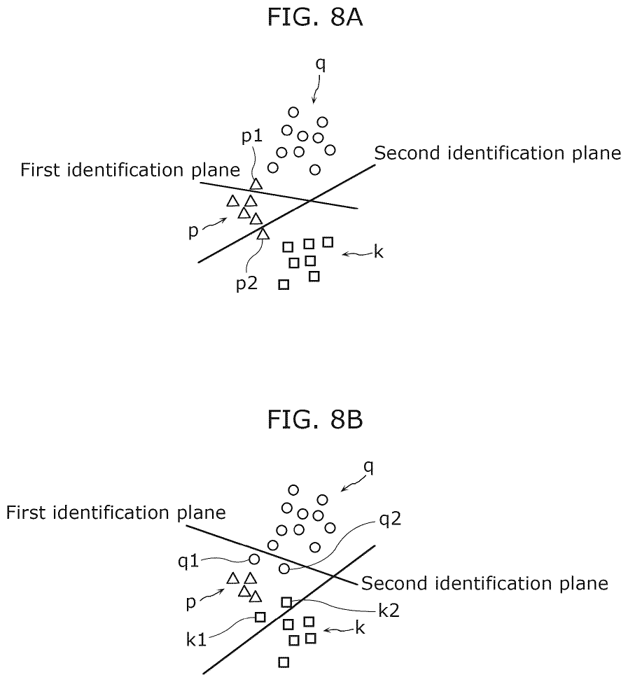

The low-frequency class may have an excessively low accuracy compared to other classes (see class p in FIG. 8A (described later), for example) and an excessively high accuracy compared to other classes (see class p in FIG. 8B (described later), for example), and thus both candidate class sets C1 and C2 are generated as candidates for the low-frequency class in step S18.

To describe using FIG. 5A as an example, first, based on the recognition rate of class A, which has the highest accuracy, class accuracy analyzer 16 identifies a class for which the accuracy difference from that recognition rate is within threshold th1. Class accuracy analyzer 16 then determines, in the order of class D, class F, and so on, whether the accuracy difference between the recognition rate of class A and the recognition rate of the stated class is within threshold th1. For example, if the accuracy difference between the recognition rate of class A and the recognition rate of class F is greater than threshold th1, only class A and class D are selected for candidate class set C1. Likewise, for the bottom class (the low-accuracy class), class accuracy analyzer 16 selects the classes to be included in candidate class set C2 using threshold th2).

FIG. 5B is a diagram illustrating a second example of a method for selecting a low-frequency class according to the present embodiment.

While FIG. 5A illustrates an example in which L classes, including class A, class D, and class F, are selected as candidate class set C1 (L is a natural number of at least 1), FIG. 5B illustrates an example in which M classes are selected as candidate class set C2 (M is a natural number of at least 1).

Note that L and M may be the same number, or may be different numbers. Although the foregoing describes candidate class sets C1 and C2 as being generated using thresholds, the classes included in candidate class sets C1 and C2 may be selected by extracting a predetermined number of classes. For example, class accuracy analyzer 16 may select a predetermined number of classes having the highest recognition rates as candidate class set C1, and select a predetermined number of classes having the lowest recognition rate as candidate class set C2.

Referring again to FIG. 4, class selector 17 selects and outputs one low-frequency class at random from candidate class sets C1 and C2 (S19). Class selector 17 selects one class at random from candidate class sets C1 and C2 and outputs the selected class as a low-frequency class to inter-class distance calculator 20. The method for random selection is not particularly limited.

Referring again to FIG. 3, next, inter-class distance calculator 20 calculates an inter-class distance between the low-frequency class selected by class selector 17 and two or more other classes (S20). Inter-class distance calculator 20 may calculate the inter-class distance between the low-frequency class and each of all the other classes among the plurality of classes excluding the low-frequency class, or may calculate the inter-class distance between the low-frequency class and a predetermined number (that is at least two) of the other classes among the plurality of classes.

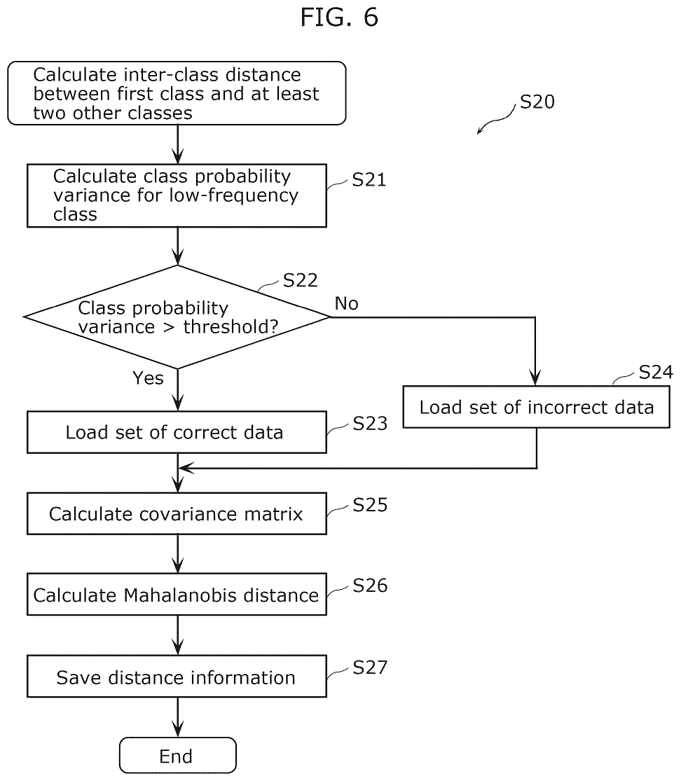

The calculation of the inter-class distances will be described with reference to FIG. 6. FIG. 6 is a flowchart illustrating the operations of step S20 of FIG. 3 (the training data generation method) in detail.

As illustrated in FIG. 6, inter-class distance calculator 20 calculates a class probability variance for the low-frequency class based on the likelihood of each of the plurality of classes included in the output from the recognition model for each item of the evaluation data for the low-frequency class (S21). “Class probability variance” refers to variance in the likelihood for each of the plurality of classes. For example, if there are three classes of objects to be recognized by the recognition model, the recognition model outputs one row and three columns including the likelihoods of the three classes as elements. If there are three classes of objects to be recognized by the recognition model, the output from the recognition model includes the likelihoods of the three classes, where one of the likelihoods of the three classes is the likelihood of the low-frequency class, and the remaining two classes are classes having likelihoods different from the low-frequency class and are referred to as “other classes”. One of the two other classes will be referred to as a “first other class”, and the other as a “second other class”.

For example, if the class of the object recognized by the recognition model from the image data that is the evaluation data is a low-frequency class, that image data will be referred to as image data (evaluation data) belonging to the low-frequency class or image data (evaluation data) of the low-frequency class.

The matrix having one row and three columns output by the recognition model for the image data belonging to the low-frequency class will be referred to as the class probability of the image data belonging to the low-frequency class. The class probability of the image data belonging to the low-frequency class may also be referred to as a “first class probability”.

Likewise, if the class of the object recognized from the image data that is the evaluation data is the first other class (or the second other class), that image data will be referred to as image data (evaluation data) belonging to the first other class (or the second other class) or image data (evaluation data) of the first other class (or the second other class).

The matrix having one row and three columns output by the recognition model for the image data (evaluation data) belonging to the first other class (or the second other class) will be referred to as the class probability of the image data belonging to the first other class (or the second other class). The class probability of the image data belonging to the first other class (or the second other class) may also be referred to as a “second class probability” (or a “third class probability”).

Inter-class distance calculator 20 calculates the class probability variance based on the first class probability for each of the plurality of items of evaluation data belonging to the low-frequency class. The “class probability variance” is the variance of the first class probability calculated from a plurality of first class probabilities. Variance is well-known in the field of statistics and the like, and will therefore not be described in detail here.

Next, inter-class distance calculator 20 determines whether the class probability variance calculated in step S21 is greater than a threshold (S22). If the class probability variance is determined to be greater than the threshold (Yes in S22), inter-class distance calculator 20 loads a set of image data, among the image data belonging to the low-frequency class, for which the inference result is correct (correct data) (S23). It can be said that when a determination of Yes is made in step S22, inter-class distance calculator 20 extracts the correct data from the image data belonging to the low-frequency class.

On the other hand, if the class probability variance is determined to be not greater than the threshold (No in S22), inter-class distance calculator 20 loads a set of image data, among the image data belonging to the low-frequency class, for which the inference result is incorrect (incorrect data) (S24). It can be said that when a determination of No is made in step S22, inter-class distance calculator 20 extracts the incorrect data from the image data belonging to the low-frequency class.

Next, based on the result of the determination made in step S22, inter-class distance calculator 20 takes (i) the image data belonging to the low-frequency class loaded in step S23 (the correct data) or (ii) the image data belonging to the low-frequency class loaded in step S24 (the incorrect data) as the evaluation data of the low-frequency class, and calculates a covariance matrix based on the inference result for each item of evaluation data of the low-frequency class (the class probability of the low-frequency class) and the inference result for each item of evaluation data in each of two or more of the other classes (the class probability of each other class) (S25).

When there are three classes of objects to be recognized by the recognition model, inter-class distance calculator 20 calculates a 3×3 covariance matrix based on (i) the variance of the plurality of first class probabilities output from the recognition model for each item of image data belonging to the low-frequency class (the plurality of items of image data loaded as a result of step S23 or step S24), (ii) the variance of the plurality of second class probabilities output from the recognition model for each of the plurality of items of image data of the first other class, (iii) the variance of the plurality of third-class probabilities output from the recognition model for each of the plurality of items of image data of the second other class, (iv) the covariance of the first class probability and the second class probability, (v) the covariance of the first class probability and the third class probability, and (vi) the covariance of the second class probability and the third class probability. Note that covariance is well-known in the field of statistics and the like, and will therefore not be described in detail here.

Next, inter-class distance calculator 20 normalizes the class probability for each class (three classes, in the above example) according to the covariance matrix calculated in step S25, and calculates a Mahalanobis distance based on the normalized class probability (S26). Inter-class distance calculator 20 calculates the distance between the centers of the two classes based on the normalized class probability as the Mahalanobis distance. In the above example, inter-class distance calculator 20 calculates a Mahalanobis distance between the low-frequency class and the first other class, and a Mahalanobis distance between the low-frequency class and the second other class.

The Mahalanobis distance between the low-frequency class and the first other class (a first Mahalanobis distance) is calculated through the following Formula 1, and the Mahalanobis distance between the low-frequency class and the second other class (a second Mahalanobis distance) is calculated by the following Formula 2.

first Mahalanobis distance={(average of second class probabilities−average of first class probabilities)*inverse of covariance matrix*(average of second class probabilities−average of second class probabilities)^{t}}^{1/2} (Formula 1)

second Mahalanobis distance={(average of third class probabilities−average of first class probabilities)*inverse of covariance matrix*(average of third class probabilities−average of first class probabilities)^{t}}^{1/2} (Formula 2)

When there are three classes of objects to be recognized by the recognition model, the first class probability, the second class probability, and the third class probability are matrices of one row and three columns as described above, and thus (average of second class probabilities-average of first class probabilities) and (average of third class probabilities-average of first class probabilities) are both a matrix having one row and three columns.

In addition, (average of second class probabilities−average of first class probabilities)^{t} is a transposition matrix (a matrix having three rows and one column) of (average of second class probabilities−average of first class probabilities), and (average of third class probabilities−average of first class probabilities)^{t} is a transposition matrix (a matrix having three rows and one column) of (average of third class probabilities−average of first class probabilities).

As described above, the first class probability is the first class probability for each of the plurality of items of image data (correct data or incorrect data) of the low-frequency class loaded based on the determination made in step S22, and thus the average of the first class probabilities is the average of the first class probabilities for the plurality of items of correct data or the plurality of items of incorrect data.

With the Mahalanobis distance, the distribution is normalized, which makes it possible to suppress the influence of bias in the class probabilities, such as outliers, on the distance. The Mahalanobis distance is an example of an “inter-class distance”.

Next, inter-class distance calculator 20 saves the calculated Mahalanobis distance (distance information) in storage (not shown) (S27).

Although inter-class distance calculator 20 calculates the Mahalanobis distance as a measure of the distance, the distance is not limited thereto, and a Euclidean distance, a Manhattan distance, a cosine similarity, or the like may be calculated instead. For example, when the bias in the data is not greater than a predetermined amount, variance in the data need not be considered, and thus a Euclidean distance that uses the class probabilities directly may be calculated.

Additionally, although the foregoing example describes calculating the inter-class distance when there are three classes of objects to be recognized by the recognition model, the configuration is not limited thereto. For example, when there are N classes of objects to be recognized by the recognition model (N is an integer of at least 4), the class probability output from the recognition model may be expressed using a matrix having one row and N columns, with the likelihood of the low-frequency class and the likelihoods of the remaining N−1 other classes as elements. In other words, the N elements included in the class probability, which is a matrix having one row and N columns output from the recognition model, are the likelihoods of the N respective classes of objects. In this case, the covariance matrix is expressed using a matrix having N rows and N columns. By applying the likelihood and covariance matrix of each of the N classes to the above-described Formula 1 and Formula 2, the inter-class distance can be calculated for a situation where there are N classes of objects to be recognized by the recognition model (N is an integer of at least 4).

Referring again to FIG. 3, mixed class selector 30 selects one other class (the second class) to be mixed with the low-frequency class (S30).

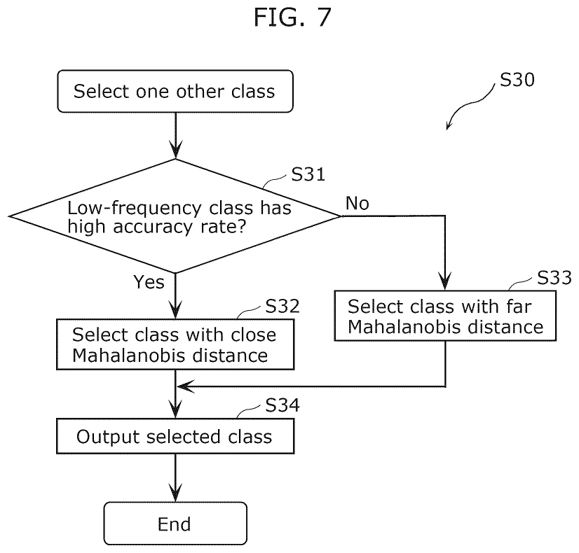

The selection of the second class will be described with reference to FIG. 7. FIG. 7 is a flowchart illustrating the operations of step S30 of FIG. 3 (the training data generation method) in detail.

As illustrated in FIG. 7, mixed class selector 30 determines whether the accuracy rate (the recognition rate) of the low-frequency class is high (S31). Specifically, mixed class selector 30 determines whether the accuracy rate of the low-frequency class is higher than a threshold.

Next, if the accuracy rate of the low-frequency class is determined to be high (Yes in S31), i.e., the accuracy rate of the low-frequency class is higher than the threshold, mixed class selector 30 selects a class, among the plurality of classes, for which the Mahalanobis distance from the low-frequency class is small, as the class to be mixed with the low-frequency class (S32). However, if the accuracy rate of the low-frequency class is determined to be low (No in S31), i.e., the accuracy rate of the low-frequency class is not higher than the threshold, mixed class selector 30 selects a class, among the plurality of classes, for which the Mahalanobis distance from the low-frequency class is large, as the class to be mixed with the low-frequency class (S33). The class having a small Mahalanobis distance may be the class having the lowest Mahalanobis distance, or may be a class randomly selected from classes having a Mahalanobis distance that is not greater than a predetermined value. The class having a large Mahalanobis distance may be a class having a Mahalanobis distance that is relatively larger than the class selected when a determination of Yes is made in step S31, or may be the class having the largest Mahalanobis distance.

Note that the case where the accuracy rate of the low-frequency class is high is assumed to be a case where, for example, the variance of the class probability is low (e.g., not greater than a threshold), and the case where the accuracy rate of the low-frequency class is low is assumed to be a case where, for example, the variance of the class probability is high (e.g., greater than the threshold).

The selection of the class to be mixed with a low-frequency class will be described with reference to FIGS. 8A and 8B. FIGS. 8A and 8B are diagrams illustrating examples of a method for selecting the class (the second class) to be mixed with the low-frequency class according to the present embodiment.

In FIGS. 8A and 8B, there are three classes, namely p, q, and k, and the class probabilities thereof are schematically indicated by triangles, squares, and circles, respectively. When the number of the plurality of classes is represented by X (X is an integer of at least 3), the class probability of each of the plurality of classes output by the recognition model is indicated as a point on X-dimensional coordinates. In the examples in FIGS. 8A and 8B, because there are three classes, the triangles, the squares, and the circles are schematically indicated as points on three-dimensional coordinates. Note that the inter-class distance described above is a distance based on a straight line distance between two points on such X-dimensional coordinates, and for example, a Euclidean distance is this straight line distance itself.

The low-frequency class is assumed to be class p (the first class). A first identification plane and a second identification plane are boundaries for identifying the respective classes. The first identification plane and the second identification plane are boundaries set as a result of the training.

In FIG. 8A, the variance of the class probabilities of class p, i.e., the variance of the class probabilities corresponding to triangles is high, and thus class probability p1 is located on the class q side from the first identification plane, and class probability p2 is located on the class k side from the second identification plane. In other words, an object corresponding to class probability p1 is an object to be recognized as belonging to class p, but is erroneously recognized as belonging to class q by the recognition model. Likewise, the object corresponding to class probability p2 is an object to be recognized as belonging to class p, but is erroneously recognized as belonging to class k by the recognition model. In addition, the class probabilities corresponding to class q, i.e., the class probabilities corresponding to circles, are all located on the class q side from the first identification plane, and all objects corresponding to the class probabilities of class q are recognized as belonging to class q by the recognition model. Likewise, the class probabilities corresponding to class k, i.e., the class probabilities corresponding to squares, are all located on the class k side from the second identification plane, and all objects corresponding to the class probabilities of class k are recognized as belonging to class k by the recognition model. In this manner, when the variance of the class probabilities of class p is high, the recognition accuracy for objects to be recognized as belonging to class p (the low-frequency class) is excessively low compared to other classes, and the recognition model may be prone to mistakenly recognizing objects to be recognized as belonging to class p as belonging to another class.

This is assumed to be due to the fact that the training data used during pre-training lacks image data between the low-frequency class and a class having a large Mahalanobis distance from the low-frequency class, and the first identification plane and the second identification plane (and particularly the first identification plane, in the example of FIG. 8A) have not been accurately trained. In this case, mixed class selector 30 selects a class (the second class) having a large Mahalanobis distance from the low-frequency class to be mixed with the low-frequency class.

In FIG. 8B, the variance of the class probabilities of class p is low, class probabilities q1 and q2 are located on the class p side from the first identification plane, and class probabilities k1 and k2 are located on the class p side from the second identification plane. In other words, an object corresponding to class probabilities q1 and q2 is an object to be recognized as belonging to class q, but is erroneously recognized as belonging to class p by the recognition model. Likewise, an object corresponding to class probabilities k1 and k2 is an object to be recognized as belonging to class k, but is erroneously recognized as belonging to class p by the recognition model. Additionally, the class probabilities of class p are all located between the first identification plane and the second identification plane, and all objects corresponding to the class probabilities of class p are recognized as belonging to class p. In this manner, when the variance of the class probabilities of objects to be recognized as belonging to class p is low, the recognition accuracy for objects to be recognized as belonging to class p (the low-frequency class) is excessively high compared to other classes, and the recognition model may be prone to mistakenly recognizing objects to be recognized as belonging to another class as belonging to the low-frequency class.

This is assumed to be due to the fact that the first identification plane and the second identification plane have not been accurately trained by the recognition model, for example, because the image data in the training data used during pre-training is similar to the image data belonging to the low-frequency class. In this case, mixed class selector 30 selects a class (the second class) having a small Mahalanobis distance from the low-frequency class to be mixed with the low-frequency class.

Referring again to FIG. 7, mixed class selector 30 outputs the selected class to data obtainer 40 (S34). Specifically, mixed class selector 30 outputs the low-frequency class and the second class (the class to be mixed with the low-frequency class) selected by mixed class selector 30 to data obtainer 40.

Referring again to FIG. 3, data obtainer 40 extracts the data from each of low-frequency class (the first class) and one other class (the second class) (S40). Data obtainer 40 loads the evaluation data of each of low-frequency class and the one other class from storage 50, for example. The number of items of data for the low-frequency class and the one other class is the same, but may be a different.

Next, mixing rate calculator 60 determines the mixing rate at which to mix the data of the low-frequency class and the one other class (S50). Mixing rate calculator 60 may, for example, determine to use a mixing rate set in advance, or may determine the mixing rate by calculating the mixing rate at random. Additionally, when a plurality of items of evaluation data are present for the one other class, mixing rate calculator 60 may determine a common mixing rate for each of the plurality of items of evaluation data for the one other class, or may determine mixing rates that are different from one another. Note that the mixing rate may be set in advance, and mixing rate calculator 60 may obtain the mixing rate by reading out that mixing rate.

Next, data mixer 70 and label mixer 80 generate training data by mixing the data (image data) and labels (S60). Data mixer 70 generates composite image data through weighted adding of the image data of the low-frequency class and the image data of the one other class at the mixing rate determined by mixing rate calculator 60. Additionally, label mixer 80 generates the composite correct label through the weighted adding of the two labels (the correct labels) at the same mixing rate as the mixing rate used for compositing the two items of image data.

Additional training data is generated by data mixer 70 mixing the image data of the one other class with the image data of the low-frequency class, and label mixer 80 mixing the labels of the one other class with the labels of the low-frequency class.

The generated training data is output by training data outputter 90 to an information processing device such as a training device that trains the recognition model.

By re-training the recognition model using the training data generated as described above, the information processing device such as a training device updates the parameters of the recognition model to new parameters, and updates the recognition model as a result. Accordingly, if, for example, the variance of the low-frequency class is at least a threshold, data that was insufficient during the advance training can be augmented, which makes it possible to re-set the identification plane between the low-frequency class and the class having a large Mahalanobis distance from the low-frequency class to a more accurate position. In the case of FIG. 8A, class q (the second class) is selected as the class having the large Mahalanobis distance, and thus the first identification plane can be re-set to a more accurate position through re-training using the composite image data in which the image data of classes p and q are mixed.

Although the foregoing example describes outputting the generated training data to an information processing device such as a training device, the configuration is not limited thereto. For example, if the training data generation device has a function block for training a recognition model, the recognition model may be re-trained using the training data generated by that function block of the training data generation device.

Additionally, if, for example, the variance of the low-frequency class is less than the threshold, re-training makes it possible to re-set an identification plane having high classification performance. In the case of FIG. 8B, class k (the second class) is selected as the class having the small Mahalanobis distance, and thus the second identification plane can be re-set to a position providing a higher classification performance through re-training using the composite image data in which the image data of classes p and k are mixed.

### Other Embodiments

A training data generation method and the like according to one or more aspects have been described thus far based on an embodiment, but the present disclosure is not limited to the embodiment. Variations on the present embodiment conceived by one skilled in the art, embodiments implemented by combining constituent elements from different other embodiments, and the like may be included as well in the present disclosure as long as they do not depart from the essential spirit of the present disclosure.

For example, although the foregoing embodiment described an example in which the training data generation device executes the processing of steps S11 to S15 in FIG. 4, the configuration is not limited thereto. The processing of steps S11 to S15 may be executed by an external device, and the training data generation device may obtain an inference result and the evaluation data used at that time from the external device.

Additionally, although the foregoing embodiment described an example in which a single class is mixed with the low-frequency class, the configuration is not limited thereto. For example, two or more classes may be selected as classes to be mixed with the low-frequency class, based on the inter-class distances. In other words, the composite image data may be image data in which two or more items of image data are mixed with the image data of the low-frequency class. The same applies to the composite correct label.

Additionally, the foregoing embodiment described an example in which, in the case of the distribution illustrated in FIG. 8A, the mixed class selector selects a class having a large Mahalanobis distance from the low-frequency class to be mixed with the low-frequency class, but the configuration is not limited thereto. The mixed class selector may select a class having a small Mahalanobis distance from the low-frequency class to be mixed with the low-frequency class. Additionally, the foregoing embodiment described an example in which, in the case of the distribution illustrated in FIG. 8B, the mixed class selector selects a class having a small Mahalanobis distance from the low-frequency class to be mixed with the low-frequency class, but the configuration is not limited thereto. The mixed class selector may select a class having a large Mahalanobis distance from the low-frequency class to be mixed with the low-frequency class.

Additionally, although the foregoing embodiment described an example in which both candidate class sets C1 and C2 are generated, the configuration is not limited thereto, and the configuration may be such that at least one of candidate class sets C1 and C2 is generated.

Additionally, the various thresholds in the foregoing embodiment are set in advance and stored in storage (not shown) of the training data generation device.

Additionally, in the foregoing embodiment and the like, the constituent elements are constituted by dedicated hardware. However, the constituent elements may be realized by executing software programs corresponding to those constituent elements. Each constituent element may be realized by a program executor such as a CPU or a processor reading out and executing a software program recorded into a recording medium such as a hard disk or semiconductor memory.

The orders in which the steps in the flowcharts are performed are for describing the present disclosure in detail, and other orders may be used instead. Some of the above-described steps may be executed simultaneously (in parallel) with other steps, and some of the above-described steps may not be executed.

Additionally, the divisions of the function blocks in the block diagrams are merely examples, and a plurality of function blocks may be realized as a single function block, a single function block may be divided into a plurality of function blocks, or some functions may be transferred to other function blocks. Additionally, the functions of a plurality of function blocks having similar functions may be processed by a single instance of hardware or software, in parallel or time-divided.

The training data generation device according to the foregoing embodiment may be implemented by a single device, or as a plurality of devices. When the training data generation device is implemented by a plurality of devices, the constituent elements of the training data generation device may be distributed throughout the plurality of devices in any manner. Furthermore, when the training data generation device is realized as a plurality of devices, the communication method used among the plurality of devices is not particularly limited, and may be wireless communication or wired communication. A combination of wireless communication and wired communication may also be used among the devices.

Each of the constituent elements described in the foregoing embodiment may be realized as software, or typically as an LSI circuit, which is an integrated circuit. These devices can be implemented individually as single chips, or may be implemented with a single chip including some or all of the devices. Although the term “LSI” is used here, other names, such as IC, system LSI, super LSI, ultra LSI, and so on are used depending on the degree of integration. Further, the manner in which the circuit integration is achieved is not limited to LSI, and it is also possible to use a dedicated circuit (a generic circuit that executes a dedicated program) or a general purpose processor. It is also possible to employ a FPGA (Field Programmable Gate Array) which is programmable after the LSI circuit has been manufactured, or a reconfigurable processor in which the connections or settings of the circuit cells within the LSI circuit can be reconfigured. Furthermore, if other technologies that improve upon or are derived from semiconductor technology enable integration technology to replace LSI circuits, then naturally it is also possible to integrate the constituent elements using that technology.

“System LSI” refers to very-large-scale integration in which multiple processing units are integrated on a single chip, and specifically, refers to a computer system configured including a microprocessor, read-only memory (ROM), random access memory (RAM), and the like. A computer program is stored in the ROM. The system LSI circuit realizes the functions of the device by the microprocessor operating in accordance with the computer program.

Additionally, one aspect of the present disclosure may be a computer program that causes a computer to execute each of the characteristic steps included in an training data generation method illustrated in any one of FIGS. 3, 4, 6, and 7.

Additionally, for example, the program may be a program to be executed by a computer. Furthermore, aspects of the present disclosure may be realized as a computer-readable non-transitory recording medium in which such a program is recorded. For example, such a program may be recorded in the recording medium and distributed or disseminated. For example, by installing a distributed program in a device having another processor and causing the processor to execute the program, the device can perform each of the processes described above.

### INDUSTRIAL APPLICABILITY

The present disclosure is useful in devices and the like that generate training data used for training in recognition models.

1. A training data generation method for generating training data for training a recognition model that is input with image data and outputs one of a plurality of classes as a class of an object present in the image data, the training data generation method comprising:
selecting a first class from the plurality of classes based on a recognition accuracy of the recognition model;
calculating an inter-class distance that is a distance between the first class and each of two or more other classes among the plurality of classes;
selecting a second class for generating the training data from the two or more other classes, based on the inter-class distance; and
generating the training data by mixing image data and labels of each of the first class selected and the second class selected.

2. The training data generation method according to claim 1, further comprising:
extracting, as at least one candidate class, at least one of a class for which the recognition accuracy is at most a first threshold, or a class for which the recognition accuracy is at least a second threshold higher than the first threshold, among the plurality of classes,
wherein in the selecting of the first class, the first class is selected from the at least one candidate class.

3. The training data generation method according to claim 2,
wherein in the selecting of the first class, the first class is selected at random from the at least one candidate class.

4. The training data generation method according to claim 1,
wherein in the calculating of the inter-class distance, the inter-class distance is calculated based on a likelihood of each of the plurality of classes, output by the recognition model.

5. The training data generation method according to claim 4, further comprising:
obtaining the likelihood for each of one or more items of first evaluation data corresponding to the first class, among evaluation data used to calculate the recognition accuracy;
determining whether a variance of the likelihood of each of the one or more items of first evaluation data is greater than a third threshold; and
determining the likelihood of the first class used to calculate the inter-class distance based on a result of the determining of whether the variance is greater than the third threshold.

6. The training data generation method according to claim 5,
wherein in the calculating of the inter-class distance, when the variance is greater than the third threshold, the inter-class distance is calculated using the likelihood of evaluation data, among the one or more items of first evaluation data, for which a recognition result is correct, and
in the calculating of the inter-class distance, when the variance is not greater than the third threshold, the inter-class distance is calculated using the likelihood of evaluation data, among the one or more items of first evaluation data, for which the recognition result is incorrect.

7. The training data generation method according to claim 4,
wherein the inter-class distance is a Mahalanobis distance, a Euclidean distance, a Manhattan distance, or a cosine similarity.

8. The training data generation method according to claim 1, further comprising:
calculating an accuracy rate of a recognition result from the recognition model for the first class,
wherein in the selecting of the second class, the second class is selected from the two or more other classes based on the accuracy rate calculated and the inter-class distance.

9. The training data generation method according to claim 8,
wherein in the selecting of the second class, when the accuracy rate of the first class is greater than a fourth threshold, a class, among the two or more other classes, for which the inter-class distance is small is selected as the second class, and
in the selecting of the second class, when the accuracy rate of the first class is not greater than the fourth threshold, a class, among the two or more other classes, for which the inter-class distance is great is selected as the second class.

10. The training data generation method according to claim 1, further comprising:
obtaining one or more items of first evaluation data corresponding to the first class and one or more items of second evaluation data corresponding to the second class, from evaluation data including image data and a label used to calculate the recognition accuracy;
obtaining a mixing rate at which to mix the one or more items of first evaluation data obtained and the one or more items of second evaluation data obtained; and
generating the training data by mixing the one or more items of first evaluation data and the one or more items of second evaluation data based on the mixing rate obtained.

11. A training data generation device that generates training data for training a recognition model that is input with image data and outputs one of a plurality of classes as a class of an object present in the image data, the training data generation device comprising:
a first selector that selects a first class from the plurality of classes based on a recognition accuracy of the recognition model;
a calculator that calculates an inter-class distance that is a distance between the first class and each of two or more other classes among the plurality of classes;
a second selector that selects a second class for generating the training data from the two or more other classes, based on the inter-class distance; and
a generator that generates the training data by mixing image data and labels of each of the first class selected and the second class selected.

12. A non-transitory computer-readable recording medium having recorded thereon a program for causing a computer to execute the training data generation method according to claim 1.
